(19) United States
(12) Patent Application Publication
(10) Pub. No.: US 2002/0126081 A1
(43) Pub. Date: Sep. 12, 2002

(54) Liquid crystal display device and method for driving the same

(75) Inventors: Katsumi Adachi, Kashiba-shi (JP); Makoto Yamakura, Moriguchi-shi (JP)

Correspondence Address: PARKHURST & WENDEL, L.L.P., Suite 210, 1421 Prince Street, Alexandria, VA, 22314-2805, US

(73) Assignee: MATSUSHITA ELECTRIC INDUSTRIAL CO., LTD.

(21) Appl. No.: 09/799,053

(22) Filed: Mar. 6, 2001

(51) Int. Cl. G09G 3/36

(52) U.S. Cl. 345/92

(57) ABSTRACT

According to the present invention, common electrode lines each making a pair with scanning line are provided and a potential of the common electrode line is alternately changed between two predetermined values to make amplitude in potential of pixel electrode larger than that of image signals thereby decreasing the amplitude of image signals. The present invention also realizes a signal source low in price and further in power-consumption therefor, thereby realizing small-sized and low-priced liquid crystal display devices suitable for portable apparatus.

### BACKGROUND OF THE INVENTION

The present invention relates to an active matrix liquid crystal display device, especially to an improvement thereof for decreasing amplitude of image signals from a signal-side circuit and those of scanning signals from a scanning-side circuit while increasing utility of the device.

For active matrix liquid crystal display devices, there is proposed an opposite constant charge coupling driving in which a storage capacitance is provided between a preceding scanning line and a pixel electrode for applying a bias-voltage to a liquid crystal in, for example, “Flat Panel Display '93 (published by Nikkei Business Publications Inc.)” on pp. 128-131. The proposal is for suppressing maximum amplitude of image signals to 5 V or around, and further for suppressing an influence caused by a parasitic capacitance or an internal DC voltage application.

The above-mentioned system accompanies with an increase in amplitude of scanning signals, on the other hand. To solve this problem, there is proposed in Japanese Unexamined Patent Publication Hei 10-39227 an improved system in which a subsidiary capacitance is provided independently from scanning lines and pulse-shaped signals is applied to the subsidiary capacitance for applying a bias voltage to a liquid crystal.

A schematic structure of the display device according to the gazette is shown in FIG. 7. In an image display area 20, there are provided plural signal lines 1 in parallel manner, and further provided plural scanning lines 2 so as to cross with the signal lines 1 at right angles. A switching element 3 is provided around each intersection area thereof. The switching element 3 controls ON/OFF of a connection between the signal line 1 and a pixel electrode 4 based on scanning signals inputted from a scanning line-driving circuit 10 via the scanning line 2. A liquid crystal layer 7 is driven by an electric field formed between the pixel electrode 4 and a counter electrode 11. Plural common electrode lines 5 each making a pair with the scanning lines 2 are provided substantially in parallel therewith. Between the pixel electrode 4 and common electrode line 5, there is formed a storage capacitance 6.

A signal line-driving circuit 9 outputs a pulse-shaped image signal of which polarity with respect to a potential V_{c} of the counter electrode 11 being inverted for each frame period.

The scanning line-driving circuit 10 includes a shift resister for generating two values of V_{off} and Vₒₙ, and further includes a buffer. The circuit 10 outputs the scanning signal of V_{off} or Vₒₙ for driving the scanning lines 2, based on a start signal Vₛ and clock signal V_{clk} inputted from signal sources (not shown).

A common electrode line-driving circuit 11 includes a switch and outputs to the common electrode line 5 one signal out of Vₑ⁻, Vₑ and Vₑ⁺ inputted from signal sources (not shown) based on the inputted signals of Vₛ and V_{Clk.}

As the switching element 3, the one with amorphous silicon (a-Si) or the one with polycrystal silicon (p-Si) is employed conventionally. Further, the one with crystal silicon (c-Si) widely applied to IC, is also employed especially for a display device of a reflection type or projection type.

On each element, a gate-drain capacitance 8 or a parasitic capacitance is inevitably formed between the scanning line 2 and pixel electrode 4 owing to a structure thereof. Therefore, the scanning signal from the scanning line-driving circuit 10 causes a negative shift in potential of the pixel electrode 4.

In the gazette, the potential of the common electrode line 5 is operated to have a change so as to compensate the potential drop of the pixel electrode 4 as a countermeasure of this defect.

The operation for driving this system will be explained with referred to as a waveform diagram shown in FIG. 8.

The scanning line-driving circuit 10 outputs scanning signals toward the scanning line 2 for setting ON the switching elements 3 connected therewith only in one horizontal scanning-term per one frame period. In other words, the potential of each scanning line 2 is increased upto Vₒₙ, in one horizontal scanning-term while being maintained at V_{off} in other horizontal scanning-terms. Therefore, the switching element 3 is set ON only in this term thereby the relevant pixel electrode 4 being connected electrically with the signal line 1.

In a horizontal scanning-term H₁ shown in the figure, the potential of the pixel electrode 4 drops to that of the signal line 1 indicated by Vₛ⁻. At this time, the signal line 1 has a negative polarity with respect to the counter electrode 11.

In the term H₁, the common electrode line 5 is operated to rise a potential thereof upto Vₑ⁺. At the time the potential of the scanning line 2 drops to V_{off} after the term H₁ passed, the potential of the pixel electrode 4 shows a slight shift to the negative side by an influence of the gate-drain capacitance 8. Here, a sum of a capacity value of the liquid crystal layer 7 and that of the storage capacitance 6 is several to several tens as large as that of the gate-drain capacitance 8.

After the term H₁ passed, the common electrode line 5 is operated to decrease the potential thereof from Vₑ⁺ to Vₑ. This operation induces a negative shift in potential of the pixel electrode 4 by an amount substantially same to the decreased amount shown in the potential of the common electrode line 5. Until a horizontal scanning-term of H₂ starts, the potential of the pixel electrode 4 is maintained since the switching element 3 is set OFF.

In the term H₂, the signal line 1 has a positive polarity with respect to the counter electrode 11 and the potential of the pixel electrode 4 raises upto that of the signal line or V_{S}⁺. In the term H₂, the common electrode line 5 is operated to decrease the potential thereof from Vₑ⁺ to Vₑ⁻. At the time the term H₂ passed and the potential of the scanning line 2 dropped to V_{off}, the potential of the pixel electrode 4 shows a slight shift to the negative side by an influence of the gate-drain capacitance 8. After the term H₂ passed, the common electrode line 5 is operated to rise the potential thereof from Vₑ⁻ upto Vₑ⁺. This operation induces a positive shift in the potential of the pixel electrode 4 by an amount substantially same to the increased amount.

In the manner as mentioned above, the pixel electrode 4 repeats an input of the image signal of which polarity with respect to the potential V_{c} of the counter electrode 11 being inverted from that of the preceding signal.

According to this system, maximum amplitude in potential of the pixel electrode 4 becomes larger than that of the image signals. However, this system requires three values for outputting to the common electrode line-driving circuit 11, and further requires for brightness-controlling a synchronized change between Vₑ⁺ and Vₑ⁻ which accompanies a complicated structure of the system. That is, for the synchronization, plural operational amplifiers with low output impedance had been employed in the signal source for outputting the signals to the common electrode line-driving circuit, for example.

This fact is a barrier against downsizing and against lowering a price of the system or an apparatus employing the system. Further, power-consumption of these operational amplifiers is a serious problem for portable apparatuses employing batteries as power sources thereof.

### SUMMARY OF THE INVENTION

The object of the present invention is to solve the above-mentioned problems thereby to provide active matrix liquid crystal display devices which can be adopted to down-sizing or lowering price.

The present invention is for active matrix liquid crystal display devices each including:

a first substrate formed thereon with signal lines provided in parallel with each other, scanning lines each crossing with the signal lines at right angles, pixel electrodes provided on areas surrounded by the signal lines and scanning lines, switching elements for controlling a connection between the pixel electrode and signal line based on scanning signals inputted from the scanning line, and common electrode lines for forming storage capacitors with the pixel electrodes, each making a pair with and being provided in parallel with the scanning line;

a second substrate provided to be opposite to the first substrate;

a liquid crystal layer sandwiched between the first and second substrates;

a counter electrode provided on the first or second substrate for forming an electric field for driving the liquid crystal layer with the pixel electrode;

a signal line-driving circuit for outputting image signals to the pixel electrode via the signal line and switching element;

scanning line-driving circuits for outputting scanning signals to the switching elements for ON/OFF controlling;

common electrode line-driving circuits for changing a potential of the common electrode line.

A liquid crystal display device of the present invention employs the common electrode line-driving circuit which changes the potential of the common electrode line between two values different from each other. The employment of the common electrode line-driving circuit outputting only two values enables a simplification in configuration of the common electrode line-driving circuit and that of the signal source for outputting signals thereto.

In a preferred mode of the present invention, the common electrode line-driving circuit changes the potential of the common electrode line from one to another value in a horizontal scanning term where the scanning signal for setting the switching elements OFF being outputted to the relevant scanning line.

In another preferred mode of the present invention, the image signals are pulse signals of which show a alternative inversion in polarity with respect to a value different from a potential of the counter electrode.

Flicker of display can be suppressed by changing a potential of the counter electrode, and brightness of display can be controlled by changing at least one value out of the two values in potential of the common electrode line.

A variable resistor is employed in the means for brightness control, for example. That is, fixed terminals thereof function as input terminals to be connected to a power supply source provided inside or outside of the device, and a middle point thereof functions as an output terminal of the means. The common electrode line-driving circuit outputs one signal out of two signals from the brightness control means, the signals being different from each other in potential. A potential of the common electrode line is controlled by changing a resistance value of the variable resistor.

In a further preferred mode of the present invention, at least one input terminal of the common electrode line-driving circuit is connected via a resistor to a power supply source provided inside or outside of the device. A signal source including the resistor and power supply source outputs two signals to the common electrode line-driving circuit, and the common electrode line-driving circuit outputs one out of two input signals toward the common electrode line.

The input terminal of the common electrode line-driving circuit can be directly connected to the resistor without interposing a decoupling capacitor therebetween.

The present invention is useful especially for a liquid crystal display device employing a signal line-driving circuit of which input signals are digital signals.

In another active matrix liquid crystal display device of the present invention, the common electrode line-driving circuit outputs a signal out of a first signal having a predetermined potential and a pair of inputted signals of which polarities with respect to the first signal are different from each other. At least one of input terminals of the common electrode line-driving circuit is connected via a resistor to a power supply source provided inside or outside of the device. That is, a simple signal source substantially configured with a power supply source and resistor can be applied to a liquid crystal display device with a common electrode line-driving circuit of three-values outputting.

In a preferred mode of the present invention, the input terminal of the common electrode line-driving circuit is directly connected to the resistor without a decoupling capacitor interposed therebetween.

In another preferred mode of the present invention, the resistor is a variable resistor of which fixed terminal is an input terminal to be connected to a power source provided inside or outside of the device, and of which middle point is an output terminal. A resistance value of the variable resistor is changed for controlling brightness of display.

In a case of reflection-type liquid crystal display device of which pixel electrode has a reflection surface for reflecting incident lights, an employment of wide common electrode lines to secure a sufficient storage capacity accompanies no care for influences to display.

In still another liquid crystal display device of the present invention, the scanning line-driving circuit and common electrode-driving circuit are provided on the same side of a display area on the first substrate, and a part of signals inputted to both circuits is outputted form sole signal source.

It is preferable that the scanning line-driving circuit and common electrode-driving circuit include silicon semiconductors in a state of single crystal, polycrystal or amorphous. It is further preferable that the switching element includes the same silicon semiconductor as those in these circuits. By employing the same material as these silicon semiconductors, formations thereof can be performed in the same process.

In a still further liquid crystal display device of the present invention, the pixel electrode has a reflection surface for reflecting incident lights.

In a case of reflection-type liquid crystal display device of which pixel electrode has a reflection surface for reflecting incident lights, a countermeasure such as increasing an intensity of lights from the backlight, lowering an aperture rate or increasing amplitude of the signals inputted to the common electrode line as in reflection-type liquid crystal display devices, accompanying bad influences is not required even when a wide common electrode line is employed for securing a storage capacitance having a sufficient capacity.

The present invention is not only for liquid crystal display devices of which pixel and counter electrodes are provided on first and second substrates, respectively, and is also applicable to an IPS (In-plane Switching) mode liquid crystal display device of which pixel and common electrodes (so-called “common electrodes”) are provided on the same substrate.

### BRIEF DESCRIPTION OF THE DRAWINGS

FIG. 1 is a circuit diagram of a liquid crystal display device in one embodiment of the present invention.

FIG. 2 is a waveform diagram showing potential of each electrode in a driving mode of the same liquid crystal display device.

FIG. 3 is a circuit diagram of a signal generator used in the same liquid crystal display device.

FIG. 4 is a circuit diagram of a liquid crystal display device in another embodiment of the present invention.

FIG. 5 is a circuit diagram of a signal generator used in the same liquid crystal display device.

FIG. 6 is a plan view showing a purview of a liquid crystal display device in still another embodiment of the present invention.

FIG. 7 is a circuit diagram of an ordinary liquid crystal display device.

FIG. 8 is a waveform diagram showing potential of each electrode in a driving mode of the same liquid crystal display device.

### DESCRIPTION OF THE PREFERRED EMBODIMENTS

Hereafter, preferred embodiments of the present invention will be described in detail referred to as the attached drawings.

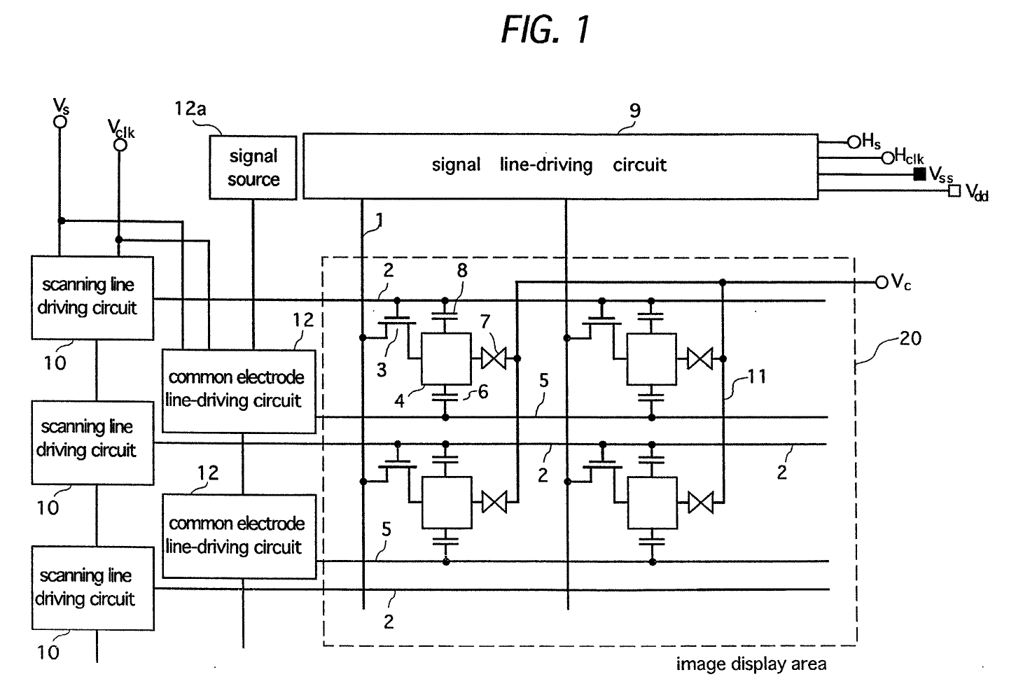

A schematic structure of a liquid crystal display device in this embodiment is shown in FIG. 1.

In an image display area 20, signal lines 1 and scanning lines 2 are provided so as to cross at right angles with each other. A switching element 3 is provided around each intersection point of the signal line 1 and scanning line 2. The switching element 3 is for controlling a connection between the signal line 1 and a pixel electrode 4, based on a scanning signal inputted from a scanning signal-driving circuit 10 via the scanning line 2. A liquid crystal layer 7 is driven by an electric field formed between the pixel electrode 4 and a counter electrode 11.

Plural common electrodes 5, each making a pair with the scanning line 2, are provided in substantially parallel therewith. Between the pixel electrode 4 and the common electrode line 5, there is formed a storage capacitance 6.

A signal line-driving circuit 9 outputs to each signal line 1 pulse-shaped image signals which show an inversion in polarity of the pulse with respect to a potential V_{c} of the counter electrode 11 in each frame period.

The scanning line-driving circuit 10 includes a shift resister for generating two values of V_{off} and Vₒₙ, and further includes a buffer. The circuit 10 outputs the scanning signal of V_{off} or Vₒₙ for driving the scanning line 2.

A common electrode line-driving circuit 12 is provided on a side of the image display area 20, where the scanning line-driving circuit 10 being provided. The common electrode line-driving circuit 12 outputs to the common electrode line 5 one signal out of two inputted signals of Vₑ⁺ and Vₑ⁻ from a signal source 12a.

Each scanning line 2 and common electrode line 5 are making a pair with each other. A potential of the scanning line 2 is set to Vₒₙ and the pixel electrodes 4 corresponding to the scanning line 2 are inputted the image signals from the signal lines 1 only in one horizontal scanning-term of the frame period. The sole scanning line 2 of which potential being set to Vₒₙ is switched among all scanning lines 2 to record a full image.

In the horizontal scanning term indicated by H₁ in the figure, a potential of the pixel electrode 4 drops to that of the signal line 1 or Vₛ⁻ when the potential of the scanning line 2 is set to Vₒₙ, In this time, the polarity of the signal line 1 is negative, and the potential of the common electrode line 5 is Vₑ⁺. When the potential of the scanning line 2 drops to V_{off} after the term H₁ the potential of the pixel electrode 4 shows a slight shift to the negative side by an influence of a gate-drain capacitance 8.

After the term H₁, the potential of the common electrode line 5 is operated to decrease from Vₑ⁺ to Vₑ⁻. This operation induces a potential drop of the pixel electrode 4 by the same amount or ΔV_{d}. The potential of the common electrode 5 is maintained even after the term H_{2.}

In the term H₂, the signal line 1 has a positive polarity and the potential of the pixel electrode 4 increases upto Vₛ⁺. At the finish of the term H₂, the potential of the pixel electrode 4 shows a slight shift to the negative side.

Then, the potential of the common electrode line 5 is operated to increase from Vₑ⁻ to Vₑ⁺. This operation induces an increase in potential of the pixel electrode 4 by an amount of ΔV_{d}.

By repeating the above-mentioned operations, amplitude larger than that of the image signals can be obtained in the potential of the pixel electrode.

According to this embodiment, the common electrode line-driving circuit outputs only two values. Therefore, an influence caused by a parasitic capacitance can be cancelled when V_{c} or the potential of the counter electrode 11 is set to be lower than the center value of the potential of the image signal by a slight amount equal to the varied amount in potential of the pixel electrode 4 shown when the scanning signal is switched from Vₒₙ to V_{off}, thereby problems caused by the parasitic capacitance such as flicker, sticking can also being restricted.

Providing the scanning line-driving circuit 10 and the common electrode line-driving circuit on the same side of the image display area 20 enables to communize the start signal Vₛ and a clock signal V_{Clk} between them. Further, it also enables a communization of other elements such as power supply wirings, thereby realizing a short and simple layout of the wiring or concentration of connection points to the exterior circuits.

Hereafter, in another view of the present invention, an improvement in a signal source for outputting signals to the common electrode will be explained.

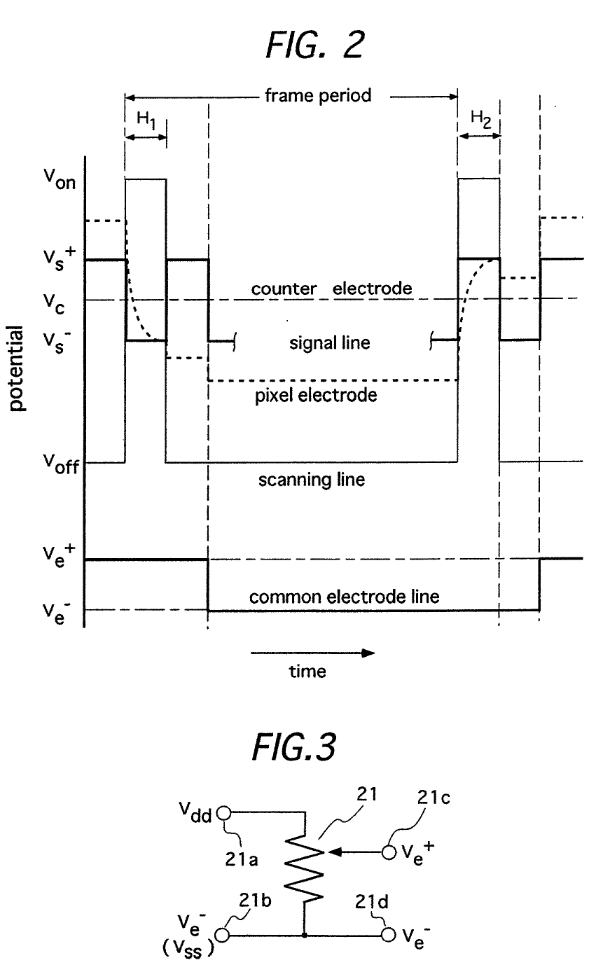

In the above-mentioned liquid crystal display device, a potential of each common electrode line 5 shows one change in one frame period for recording a full image in a screen as shown in FIG. 2. That is, the common electrode line-driving circuit 12 operates only one or two common electrode lines 5 to change potentials thereof, and it leaves others as they are in the same horizontal scanning-term.

Here, an allowable maximum value in output impedance of the common electrode-driving circuit 12 is, however it depends on a size of the panel, several k Ω in general. In consideration with this fact and outputting two values, it appears that a means having a simple structure as shown in FIG. 3 can perform brightness control of display. A variable resister 21 is connected between a power supply source with a potential of V_{dd} and ground with a potential of Vₛₛ at fixed terminals 21a and 21b. From a middle point of the resister 21 or a terminal 21c is outputted Vₑ⁺ to the common electrode line-driving circuit 12. From a terminal 21d is outputted the ground potential Vₛₛ as Vₑ⁻. In this manner, the present invention enables a usage of a signal source simple in structure and small in power-consumption, which requires no operational amplifier as in the ordinary display device with common electrode line-driving circuit of three values-outputting. Further, a common 5 V power supply source can be applied to the above power supply source since the ordinary panel with nematic liquid crystal can display normal images at around 5 V in Vₛₛ and 4 to 5 V in difference between Vₑ⁺ and Vₑ⁻. This enables an employment of a common inexpensive power supply source.

If the brightness control is not required or the control is performed by the signal line-driving circuit 9 itself, Vₑ⁺ and Vₑ⁻ can be obtained directly from the power supply source without the variable resister 21.

Of course, it is also possible to fix V_{dd} to Vₑ⁺ while setting Vₑ⁻ variable, in reverse manner.

In the ordinary, signals from the signal source was inputted to the common electrode line-driving circuit after smoothing using a capacitor.

In the liquid crystal display device in the above-mentioned example, when a potential of one common electrode line rises from Vₑ⁻ upto Vₑ⁺, all other common electrodes or others excepting one performing a change in potential form Vₑ⁺ to Vₑ⁻ in reverse manner maintain the potential thereof at Vₑ⁺ or Vₑ⁻, since each common electrode line shows sole change in potential in every frame period. That is, a fluctuation in output signal Vₑ⁺ from the signal generator is relaxed due to half of the common electrode lines of which potential being maintained at Vₑ⁺. This indicates that these other common electrode lines perform a role of a decoupling capacitor. Therefore, an output terminal 21c of the signal generator shown in FIG. 3 can be directly connected to an input terminal of the common electrode line-driving circuit. Such configuration is especially effective to the device of which signal line-driving circuit is inputted digital signals, which has a hardness in bright control of full screen.

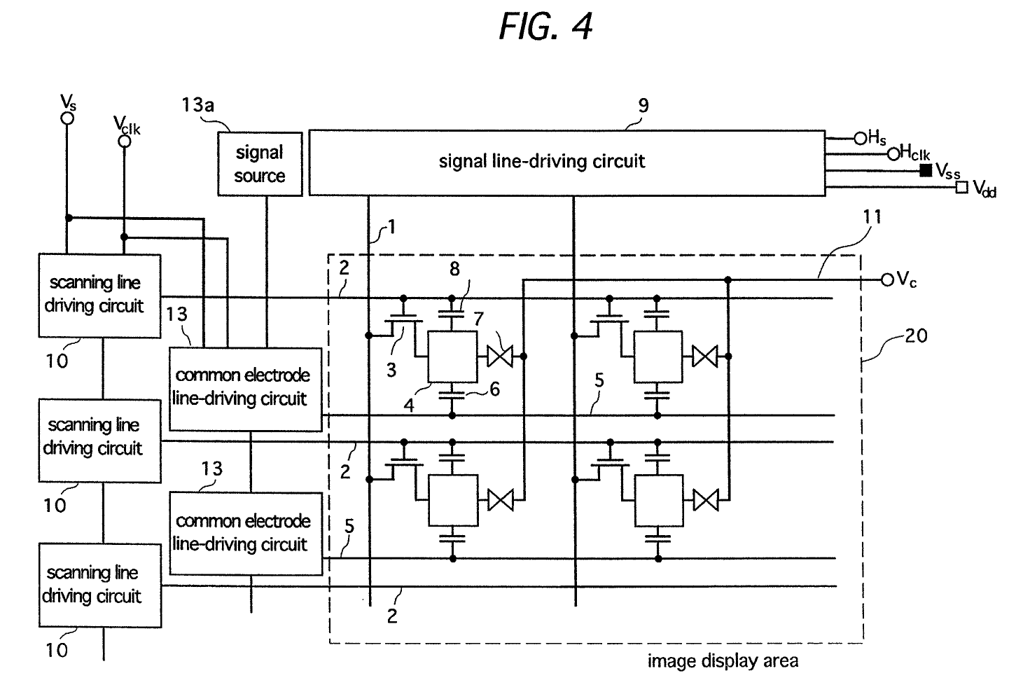

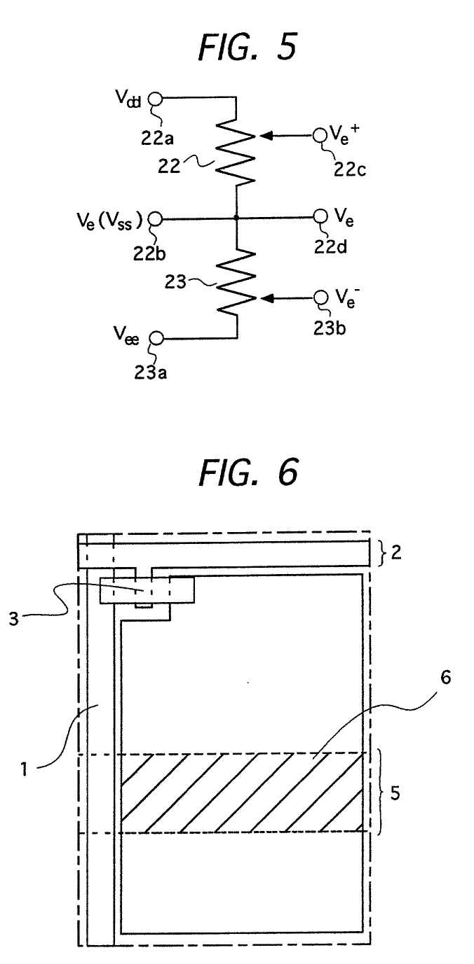

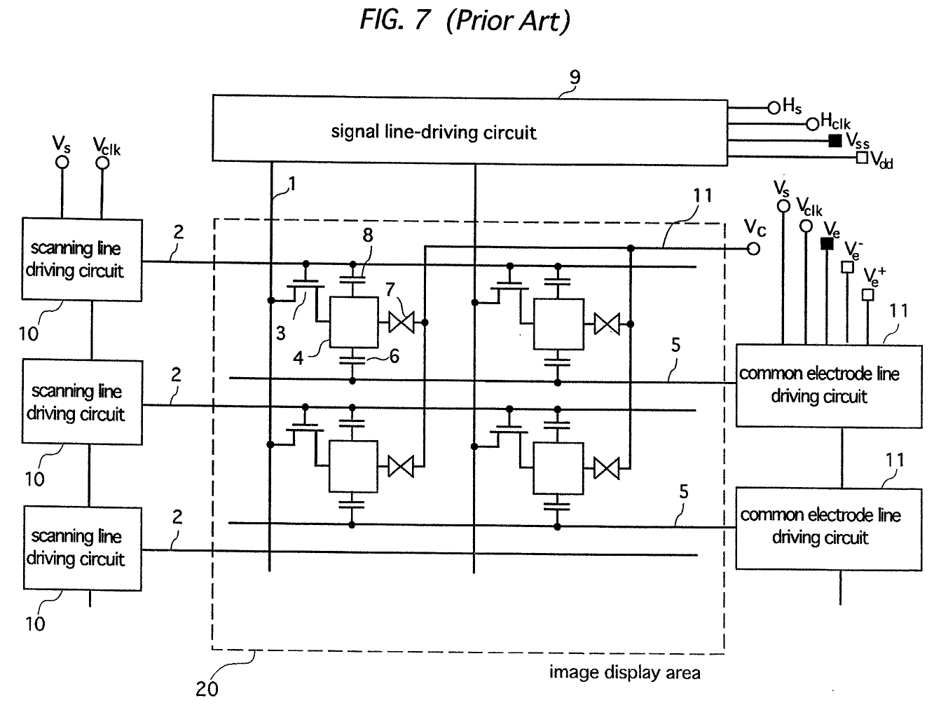

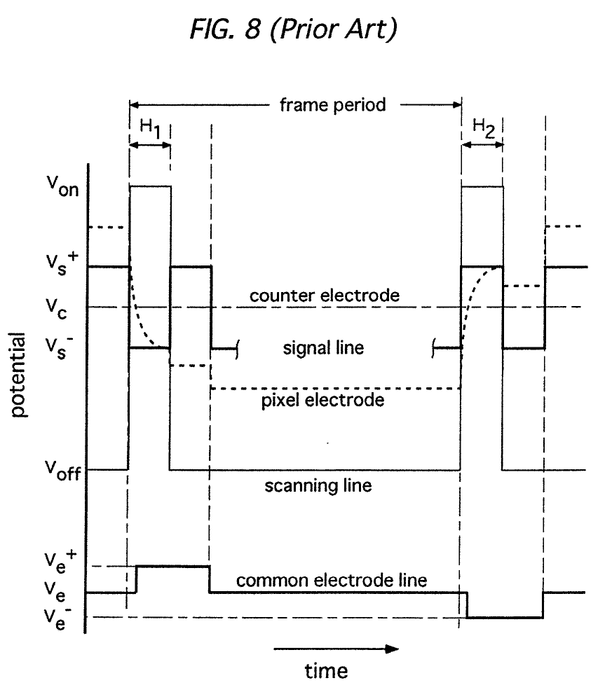

The above mentioned connection between the signal source and common electrode line-driving circuit without decoupling capacitor may also be applied to the ordinary liquid crystal display device of which common electrode line-driving circuit outputs three values. That is, a signal source 13a is includes a pair of variable resistors 22 and 23 as shown in FIG. 5. Input terminal 22b is connected to ground, and input terminals 22a and 23a are connected to common 5 V power supply sources (not shown), respectively. Middle points of the variable resistors function as output terminals 22c and 23b for outputting Vₑ⁺ and Vₑ⁻ respectively, and from a terminal 22d is outputted the ground potential as Vₑ. Without smoothing by the decoupling capacitor, Vₑ⁺ and Vₑ⁻ are outputted directly to a common electrode line-driving circuit 13 of a liquid crystal display device shown in FIG. 4.

The present invention is useful especially to so-called reflection-type liquid crystal display with no backlight.

As shown in FIG. 6, the pixel electrodes 4 and common electrode lines 5 are provided in different layers on the same substrate in general. In so-called transmission-type liquid crystal display device having a backlight, the pixel electrodes 4 and common electrode lines 5 are both made of a transparent conductive material such as ITO (an indium-tin-oxide). A capacity of the storage capacitance 6 formed between the pixel electrode 4 and common electrode line 5 on a region indicated by slashed lines in the figure depends on a width of the common electrode line 5 or amplitude of signals inputted thereto.

In the transmission-type liquid crystal display device, the lights projected by the backlight transmit through the common electrode line 5 at the region on which the storage capacitance 6 is formed. Therefore, when the common electrode is widened, a countermeasure such as increasing an intensity of lights from the backlight, lowering an aperture rate or increasing amplitude of the signals inputted to the common electrode line is required in order to maintain brightness of display.

On the other hand, there is no need for such countermeasure in the reflection-type liquid crystal display device with pixel electrodes 5 having reflection surfaces. That is, the storage capacitance 6 with a sufficient capacity can be obtained while maintaining the aperture rate large and amplitude of inputted signals to the common electrode lines small. The pixel electrode 5 is made of, for example, aluminum.

1. A liquid crystal display device comprising:
a first substrate formed thereon with signal lines provided in parallel with each other, scanning lines each crossing with said signal lines at right angles, pixel electrodes provided on areas surrounded by said signal lines and scanning lines, switching elements for controlling a connection between said pixel electrode and signal line based on scanning signals inputted from said scanning line, and common electrode lines for forming storage capacitors with said pixel electrodes, each common electrode line making a pair with and being provided in parallel with said scanning line;
a second substrate provided to be opposite to said first substrate;
a liquid crystal layer sandwiched between said first and second substrates;
a counter electrode provided on said first or second substrate for forming an electric field for driving said liquid crystal layer with said pixel electrode;
a signal line-driving circuit for outputting image signals to said pixel electrode via said signal line and switching element;
scanning line-driving circuits for outputting said scanning signals to said switching elements;
common electrode line-driving circuits for changing a potential of said common electrode line between predetermined two values different from each other.

2. The liquid crystal display device in accordance with claim 1, wherein said common electrode line-driving circuit changes said potential of the common electrode line from one to another value in a horizontal scanning-term where said scanning signal for setting said switching elements OFF being outputted to the relevant scanning line.

3. The liquid crystal display device in accordance with claim 1, wherein said image signal is a pulse signal of which polarity with respect to a predetermined value different from a potential of said counter electrode is inverted alternatively.

4. The liquid crystal display device in accordance with claim 1, further comprising a means for changing a potential of said counter electrode to suppress flicker of display.

5. The liquid crystal display device in accordance with claim 1, further comprising a brightness control means for changing at least one out of said two values in the potential of said common electrode line to control brightness of display.

6. The liquid crystal display device in accordance with claim 5, wherein said common electrode line-driving circuit outputs to said common electrode line one signal out of two signals from said brightness control means, which are different from each other in potential, and said brightness control means includes a variable resistor of which fixed terminals being input terminals for connecting to a power supply source provided inside or outside of the device and a middle point thereof being an output terminal of the means.

7. The liquid crystal display device in accordance with claim 1, wherein said common electrode line-driving circuit outputs one signal out of two signals from said brightness control means, which are different from each other in potential, and at least one of input terminals of said common electrode line-driving circuit is connected via a resistor to a power supply source provided inside or outside of the device.

8. The liquid crystal display device in accordance with claim 7, wherein said input terminal of said common electrode line-driving circuit is directly connected to said resistor.

9. The liquid crystal display device in accordance with claim 1, wherein signals to be inputted to said signal line-driving circuit are digital signals.

10. The liquid crystal display device in accordance with claim 1, wherein said scanning line-driving circuit and common electrode-driving circuit are provided on the same side of a display area on said first substrate, and a part of signals inputted to both circuits is outputted form sole signal source.

11. The liquid crystal display device in accordance with claim 1, wherein said scanning line-driving circuit and common electrode-driving circuit includes a silicon semiconductor in a state of single crystal, polycrystal or amorphous.

12. The liquid crystal display device in accordance with claim 11, wherein said switching element includes the same silicon semiconductor as said scanning line-driving circuit and common electrode-driving circuit include therein.

13. The liquid crystal display device in accordance with claim 1, wherein said pixel electrode has a reflection surface for reflecting incident lights.

14. A liquid crystal display device comprising:
a first substrate formed thereon with signal lines provided in parallel with each other, scanning lines each crossing with said signal lines at right angles, pixel electrodes provided on areas surrounded by said signal lines and scanning lines, switching elements for controlling a connection between said pixel electrode and signal line based on scanning signals inputted from said scanning line, and common electrode lines for forming storage capacitors with said pixel electrodes, each common electrode line making a pair with and being provided in parallel with said scanning line;
a second substrate provided to be opposite to said first substrate;
a liquid crystal layer sandwiched between said first and second substrates;
a counter electrode provided on said first or second substrate for forming an electric field for driving said liquid crystal layer with said pixel electrode;
a signal line-driving circuit for outputting image signals to said pixel electrode via said signal line and switching element;
scanning line-driving circuits for outputting scanning signals to said switching elements;
common electrode line-driving circuits for changing a potential of said common electrode line, wherein said common electrode line-driving circuit selectively and alternatively outputs one signal out of three signals including a first signal having a predetermined potential and a pair of inputted signals of which polarity with respect to said first signal are different from each other, and at least one of input terminals of said common electrode line-driving circuit is connected via a resistor to a power supply source provided in side or out side of the device.

15. The liquid crystal display device in accordance with claim 14, wherein said input terminal of the common electrode line-driving circuit is directly connected to said resistor.

16. The liquid crystal display device in accordance with claim 14, wherein said resistor is a variable resistor of which fixed terminal is an input terminal and a middle point thereof is an output terminal, and the resistance value thereof being changed for controlling brightness of display.

17. The liquid crystal display device in accordance with claim 1, wherein said pixel electrode has a reflection surface for reflecting incident lights.

18. A liquid crystal display device comprising:
a first substrate formed thereon with signal lines provided in parallel with each other, scanning lines each crossing with said signal lines at right angles, pixel electrodes provided on areas surrounded by said signal lines and scanning lines, switching elements for controlling a connection between said pixel electrode and signal line based on scanning signals inputted from said scanning line, and common electrode lines for forming storage capacitors with said pixel electrodes, each common electrode line making a pair with and being provided in parallel with said scanning line;
a second substrate provided to be opposite to said first substrate;
a liquid crystal layer sandwiched between said first and second substrates;
a counter electrode provided on said first or second substrate for forming an electric field for driving said liquid crystal layer with said pixel electrode;
a signal line-driving circuit for outputting image signals to said pixel electrode via said signal line and switching element;
scanning line-driving circuits for outputting said scanning signals to said switching elements;
common electrode line-driving circuits for changing a potential of said common electrode line, wherein said scanning line-driving circuit and common electrode-driving circuit are provided on the same side of a display area on said first substrate, and a part of signals inputted to both circuits being outputted from sole signal source.

19. The liquid crystal display device in accordance with claim 18, wherein said scanning line-driving circuit and common electrode-driving circuit includes a silicon semiconductor in a state of single crystal, polycrystal or amorphous.

20. A liquid crystal display device comprising:
a first substrate formed thereon with signal lines provided in parallel with each other, scanning lines each crossing with said signal lines at right angles, pixel electrodes provided on areas surrounded by said signal lines and scanning lines, switching elements for controlling a connection between said pixel electrode and signal line based on scanning signals inputted from said scanning line, and common electrode lines for forming storage capacitors with said pixel electrodes, each common electrode line making a pair with and being provided in parallel with said scanning line;
a second substrate provided to be opposite to said first substrate;
a liquid crystal layer sandwiched between said first and second substrates;
a counter electrode provided on said first or second substrate for forming an electric field for driving said liquid crystal layer with said pixel electrode;
a signal line-driving circuit for outputting image signals to said pixel electrode via said signal line and switching element;
scanning line-driving circuits for outputting said scanning signals to said switching elements;
common electrode line-driving circuits for changing a potential of said common electrode line, wherein said pixel electrode has a reflection surface for reflecting incident lights.

21. A method for driving a liquid crystal display device comprising:
a first substrate formed thereon with signal lines provided in parallel with each other, scanning lines each crossing with said signal lines at right angles, pixel electrodes provided on areas surrounded by said signal lines and scanning lines, switching elements for controlling a connection between said pixel electrode and signal line based on scanning signals inputted from said scanning line, and common electrode lines for forming storage capacitors with said pixel electrodes, each common electrode line making a pair with and being provided in parallel with said scanning line;
a second substrate provided to be opposite to said first substrate;
a liquid crystal layer sandwiched between said first and second substrates;
a counter electrode provided on said first or second substrate for forming an electric field for driving said liquid crystal layer with said pixel electrode, wherein potential of said common electrode line is changed from one to another value out of two predetermined values in a horizontal scanning-term where said scanning signal for setting said switching elements OFF being outputted to the relevant scanning line.

22. The method for driving a liquid crystal display device in accordance with claim 21, wherein the potential of said counter electrode is changed for suppressing flicker of display.

23. The method for driving a liquid crystal display device in accordance with claim 21, wherein the potential of said common electrode line is additionally changed for controlling brightness of display.
